(19) United States
(12) Patent Application Publication
(10) Pub. No.: US 2019/0110193 A1
(43) Pub. Date: Apr. 11, 2019

(54) USING AN OPTICAL OR ELECTRONIC GATEWAY TAG TO AUTOMATICALLY WIRELESSLY ACCESS THE CONTROL SYSTEM OF A MACHINE USING A WEB-BASED PROTOCOL

(71) Applicant: FIPAK Research And Development Company, Rowley, MA (US)

(72) Inventors: Antoine Hauville, La Londe (FR); Stephane Hauville, Byfield, MA (US)

(21) Appl. No.: 16/125,268

(22) Filed: Sep. 7, 2018

Related U.S. Application Data
(60) Provisional application No. 62/555,450, filed on Sep. 7, 2017.

(51) Int. Cl. H04W 12/00; H04L 29/06; H04W 12/08; H04L 29/08; H04L 12/66; H04W 76/10

(52) U.S. Cl. CPC H04W 12/00407; H04L 63/0218; H04W 12/08; H04L 67/02; H04L 12/66; H04W 76/10; H04L 67/104

(57) ABSTRACT

A system comprising: a machine comprising: a local, wireless, peer-to-peer network with a unique network identifier and a unique machine identifier; an interface for enabling web browser-based communications over the network; a dashboard generator for providing a machine control dashboard for controlling operation of the machine over the network; and a gateway tag associated with the machine for wirelessly providing all of the information required to access the network and the machine control dashboard for the machine; and a portable device enabled for web browser-based communications over the network and configured to acquire the gateway tag and to use the information from the gateway tag to automatically connect to the network and the machine so that the machine control dashboard is displayed on the portable device, whereby to enable the machine to be controlled by the machine control dashboard displayed on the portable device.

### REFERENCE TO PENDING PRIOR PATENT APPLICATION

This patent application claims benefit of pending prior U.S. Provisional Patent Application Ser. No. 62/555,450, filed Sep. 7, 2017 by FIPAK Research And Development Company and Antoine Hauville for USING A QR CODE TO ACCESS A WIRELESS WEB-BASED MACHINE CONTROL SYSTEM (Attorney's Docket No. FIPAK-19 PROV), which patent application is hereby incorporated herein by reference.

### FIELD OF THE INVENTION

This invention relates to machine control systems in general, and more particularly to methods and apparatus for accessing machine control systems.

### BACKGROUND OF THE INVENTION

Today all kinds of machines (e.g., ATMs, gas pumps, vending machines, etc.) in public or private spaces have different means of interfacing with humans, usually by means of a combination of built-in buttons, markings (mostly in English) and screens usually found on the front of the machines. When the machines are needed, and once they have been spotted in the area where they are installed (which is not always easy to do), a user places himself/herself in front of the machine in order to know, first, if the machine is “on”, available, in good working order and ready for use in a language that he/she can understand, especially when travelling overseas; and then the user can use the built-in buttons, markings and screen to operate the machine.

More recently, the built-in buttons and single-language markings on the machines have been replaced by built-in, multi-language touchscreens.

Unfortunately, these newer touchscreen machines are more expensive to manufacture and more fragile in use. In addition, these newer touchscreen machines are more prone to vandalism, especially if the touchscreen machines are fitted with coin-operating functions. Thus, in the end, these newer touchscreen machines are more expensive to manufacture and maintain, more prone to vandalism, and are not necessarily more user-friendly.

In addition to the foregoing, “connected objects” or “connected machines” (e.g., Internet-connected thermostats, Internet-connected video cameras, Internet-connected lighting, etc.) have recently appeared, mostly in households and offices, which allow users to control the “connected object” or “connected machine” by means of a smartphone or tablet. In this approach, the “connected object” or “connected machine” is connected to the Internet, the smartphone or tablet is connected to the Internet, and then the smartphone or tablet runs an “app” which allows the smartphone or tablet to control the “connected object” or “connected machine” via the Internet connection. The “connected object” or “connected machine”, and the smartphone or tablet, may be wirelessly connected to the Internet via cellular telephone technology (e.g., GSM) or WiFi. These “connected objects” or “connected machines” typically have a simplified construction, and they usually do not have built-in screens, but they require that the user download a specific “app” from the Internet onto their smartphone or tablet in order to enable the smartphone or tablet to interface with the “connected object” or “connected machine”.

While this approach is highly useful, it begins to break down where the user needs to control a large number (e.g., hundreds) of “connected objects” or “connected machines”, since then the user must download a large number (e.g., hundreds) of specific “apps” in order to run those “connected objects” or “connected machines”, which in the end will clutter the “desktop” and memory of the user's smartphone or tablet. Furthermore, if a user needs to enable a new “connected object” or “connected machine” when the user is at a location where there is no Internet connection available (e.g., due to lack of service or due to security restrictions), the user will be unable to download the necessary “app” to their smartphone or tablet, and hence will be unable to interface with the “connected object” or “connected machine” until he/she can download the specific “app” needed to run that “connected object” or “connected machine”.

Thus there is a need for a new way to control a machine (which term is intended to encompass an object) which avoids the difficulties of the prior art.

### SUMMARY OF THE INVENTION

The present invention provides a new way to control a machine (which term is intended to encompass an object) which avoids the difficulties of the prior art.

More particularly, the present invention enables anyone with a smartphone, tablet, personal computer, smartwatch, smartglasses, etc., equipped with optical and/or electronic tag reading capability and wireless communication capability, to wirelessly connect with any machine having a wireless web-based machine control system using (i) a “universal gateway app” installed on their smartphone, tablet, personal computer, smartwatch, smartglasses, etc., and (ii) a web browser also installed on their smartphone, tablet, personal computer, smartwatch, smartglasses, etc., such that the user can control the operation of the machine using their smartphone, tablet, personal computer, smartwatch, smartglasses, etc., all without requiring Internet access by either the smartphone, tablet, personal computer, smartwatch, smartglasses, etc. or the machine.

Note that the term “wireless web-based machine control system” as used herein is intended to mean a machine control system which is accessed by a machine-generated peer-to-peer wireless network communicating via a web-based protocol, e.g., a Hypertext Markup Language-type (HTML-type) protocol—it is not intended to mean a machine control system which is accessed by the Internet via a web-based protocol.

In one form of the invention, there is provided a system comprising:

a machine comprising:
a local, wireless, peer-to-peer network with a unique network identifier and a unique machine identifier;
an interface for enabling web browser-based communications over the network;
a dashboard generator for providing a machine control dashboard for controlling operation of the machine over the network; and
a gateway tag associated with the machine for wirelessly providing all of the information required to access the network and the machine control dashboard for the machine; and

a portable device enabled for web browser-based communications over the network and configured to acquire the gateway tag and to use the information from the gateway tag to automatically connect to the network and the machine so that the machine control dashboard is displayed on the portable device, whereby to enable the machine to be controlled by the machine control dashboard displayed on the portable device.

In another form of the invention, there is provided a method comprising:

providing a system comprising:
a machine comprising:
   a local, wireless, peer-to-peer network with a unique network identifier and a unique machine identifier;
   an interface for enabling web browser-based communications over the network;
   a dashboard generator for providing a machine control dashboard for controlling operation of the machine over the network; and
   a gateway tag associated with the machine for wirelessly providing all of the information required to access the network and the machine control dashboard for the machine; and
a portable device enabled for web browser-based communications over the network and configured to acquire the gateway tag and to use the information from the gateway tag to automatically connect to the network and the machine so that the machine control dashboard is displayed on the portable device, whereby to enable the machine to be controlled by the machine control dashboard displayed on the portable device;

using the portable device to acquire the gateway tag and automatically connect to the network and the machine so that the machine control dashboard is displayed on the portable device; and

controlling operation of the machine over the network using the machine control dashboard on the portable device.

In another form of the invention, there is provided a machine comprising:

a local, wireless, peer-to-peer network with a unique network identifier and a unique machine identifier;

an interface for enabling web browser-based communications over the network;

a dashboard generator for providing a machine control dashboard for controlling operation of the machine over the network; and

a gateway tag associated with the machine for wirelessly providing all of the information required to access the network and the machine control dashboard for the machine.

In another form of the invention, there is provided a software app for a portable device, wherein the portable device is enabled for web browser-based communications over a network and configured to acquire a gateway tag, the software app being configured to use the information from the gateway tag to automatically connect to the network, and to a machine also connected to the network, so that a machine control dashboard provided to the network is displayed on the portable device.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIG. 1 is a schematic view showing an exemplary gas station application using the present invention;

FIG. 2 is a schematic view showing an exemplary laboratory application using the present invention;

FIG. 3 is a schematic view showing the primary components of the present invention in the context of the exemplary laboratory application of FIG. 2; and

FIG. 4 is a schematic view of a novel system embodying the present invention.

### DETAILED DESCRIPTION OF THE PREFERRED EMBODIMENTS

The present invention provides a new way to control a machine (which term is intended to encompass an object) which avoids the difficulties of the prior art.

More particularly, the present invention enables anyone with a smartphone, tablet, personal computer, smartwatch, smartglasses, etc., equipped with optical and/or electronic tag reading capability and wireless communication capability, to wirelessly connect with any machine having a wireless web-based machine control system using (i) a “universal gateway app” installed on their smartphone, tablet, personal computer, smartwatch, smartglasses, etc., and (ii) a web browser also installed on their smartphone, tablet, personal computer, smartwatch, smartglasses, etc., such that the user can control the operation of the machine using their smartphone, tablet, personal computer, smartwatch, smartglasses, etc., all without requiring Internet access by either the smartphone, tablet, personal computer, smartwatch, smartglasses, etc. or the machine.

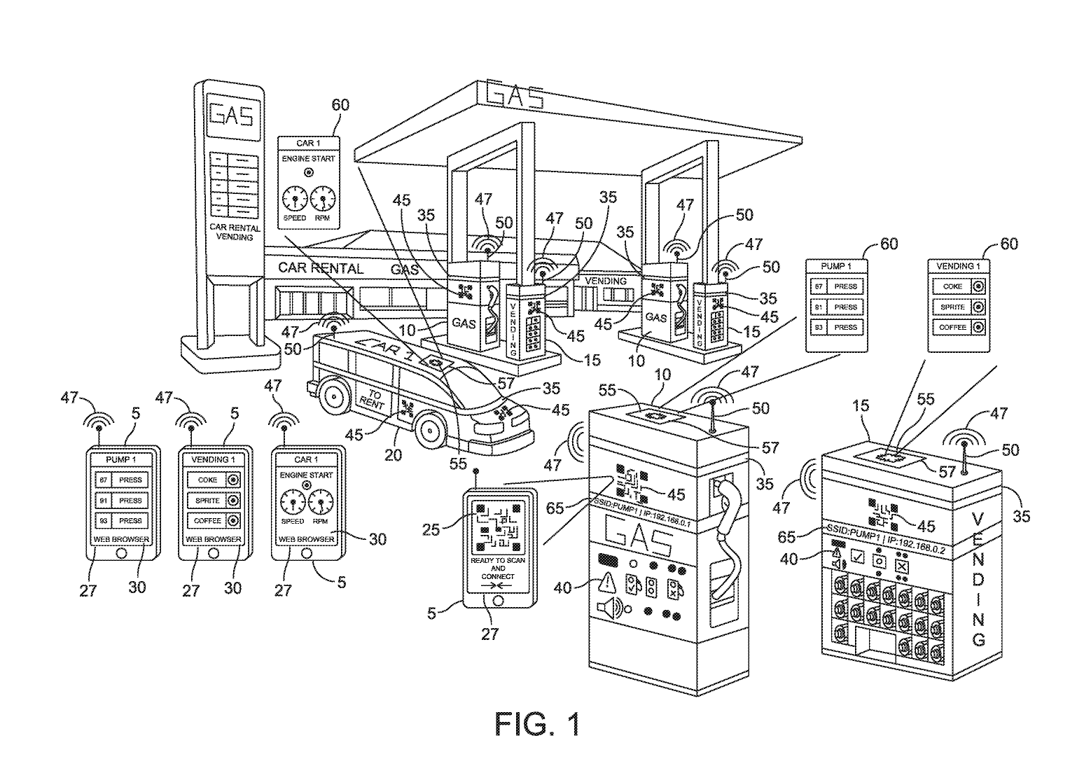

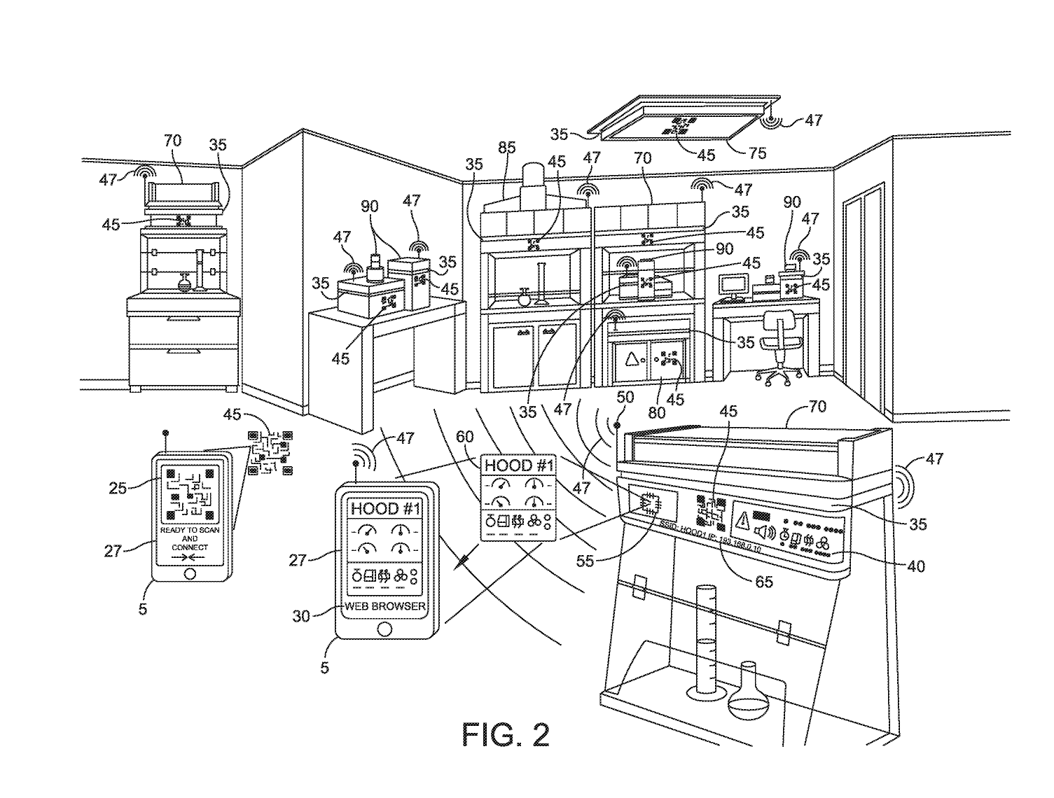

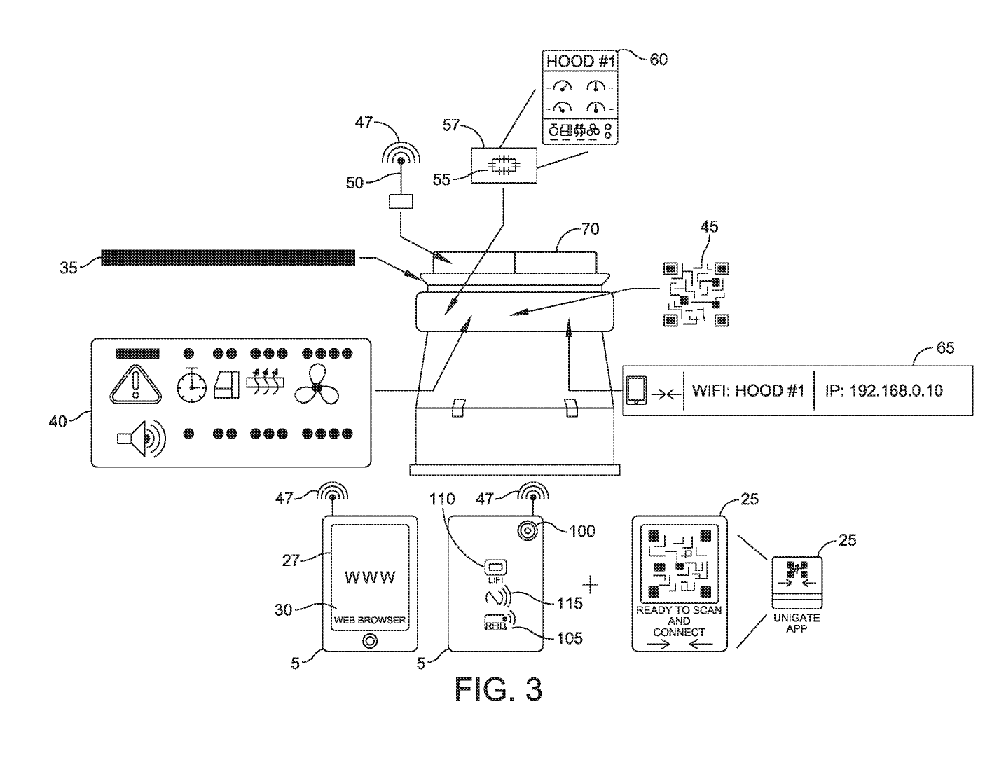

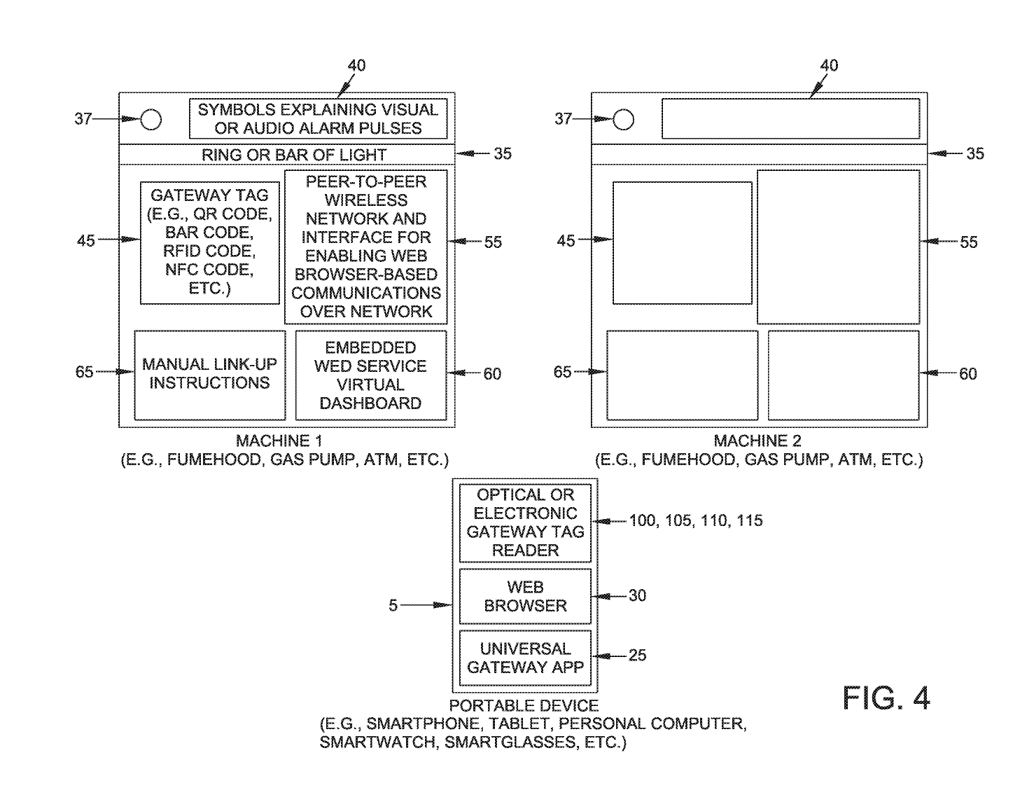

The present invention will first be described in the context of an exemplary gas station application (FIG. 1), then it will be described in the context of an exemplary laboratory environment (FIGS. 2 and 3), and then it will be described in the context of a generic application (FIG. 4).

1. Exemplary Gas Station Application (FIG. 1)

As stated above, the present invention enables anyone with a smartphone, tablet, personal computer, smartwatch, smartglasses, etc. (generally referred to herein as a “portable” or “handheld” device, which terms are intended to be used interchangeably for purposes of the present invention—see handheld device 5), equipped with optical and/or electronic reading capability and wireless communication capability, to wirelessly connect with any machine having a wireless web-based machine control system (see gas pump 10, vending machine 15 and car 20) using (i) a “universal gateway app” 25 (shown running on display screen 27 of handheld device 5) installed on their smartphone, tablet, personal computer, smartwatch, smartglasses, etc., and (ii) a web browser 30 (shown running on display screen 27 of handheld devices 5) also installed on their smartphone, tablet, personal computer, smartwatch, smartglasses, etc., such that the user can control the operation of the machine (e.g., gas pump 10, vending machine 15 or car 20) using their smartphone, tablet, personal computer, smartwatch, smartglasses, etc., all without requiring Internet access by either the smartphone, tablet, personal computer, smartwatch, smartglasses, etc. or the machine.

In order that machines equipped with this wireless web-based machine control system can be instantly recognized from afar, the machines are preferably equipped with a “pulsation by light” communication ring system 35 (see the respective light rings on gas pump 10, vending machine 15 and car 20). These “pulsation by light” communication ring systems 35 act as a simple and elegant beacon to alert people that the machine is equipped with the wireless web-based control system of the present invention. This “pulsation by light” communication ring system 35 can also operate to let users know, by light pulsation codes, the operating status of the machine. By way of example but not limitation, the “pulsation by light” communication ring system 35 can advise if the machine is in one of the following states: ready for use, in use, or out of order (see further discussion below).

Furthermore, the “pulsation by light” communication ring system 35 can be coupled with sound pulsations (e.g., delivered by a loudspeaker 37, not shown in FIG. 1 but shown in FIG. 4, incorporated into the machine) which can also give users useful information about the status of the machine (such as where the machine is not in direct line-of-sight with the user).

An explanation about the meaning of the light pulsations and/or the sound pulsations can be affixed to the front (or another portion) of each machine as a series of symbols (see machine status symbols 40 printed on gas pump 10, vending machine 15 and car 20) which provide the meaning of the light pulsations and/or sound pulsations, e.g., the meaning associated with one pulse of light or sound, the meaning associated with two pulses of light or sound, the meaning associated with three pulses of light or sound, etc. Embodying the explanation of the meaning of the light pulsations and/or the sound pulsations as a series of machine status symbols 40 on the front (or another portion) of the machine provides the advantage of not having to manage any specific written languages.

Machines equipped with the wireless web-based machine control system of the present invention can also be easily recognized by their gateway tag 45 (shown in FIG. 1 as an optical QR code but which can also be an optical bar code, an electronic NFC code or an electronic RFID code, etc.) which is affixed to the front (or another portion) of the machine and which acts as a gateway for accessing the control systems which control operation of the machines.

Once a user has scanned the gateway tag 45 on the front (or another portion) of the machine with their handheld device, the universal gateway app 25 installed on their handheld device (see display screen 27 of handheld device 5), using the gateway tag 45 as an optical or electronic linking key, will then automatically connect the handheld device to the machine's closed peer-to-peer proximity wireless communication network 47, which may be implemented by (i) a radio frequency-based (RF-based) networking technology (see antennas 50 on gas pump 10, vending machine 15 and car 20), or (ii) a closed peer-to-peer LiFi (Light Fidelity) wireless optical networking technology that uses light-emitting diodes (LEDs) for data transmission (which is preferably coupled with the “pulsation by light” communication ring system 35 already installed on the machine, i.e., the “pulsation by light” communication ring system 35 can be used to provide the output side of the machine's closed peer-to-peer LiFi (Light Fidelity) wireless optical networking technology—the input side of the machine's closed peer-to-peer LiFi (Light Fidelity) wireless optical networking technology will be discussed below).

By way of example but not limitation, the handheld device (e.g., the smartphone, tablet, personal computer, smartwatch, smartglasses, etc.) may comprise a camera for scanning gateway tag 45 where gateway tag 45 comprises an optical tag such as a QR code, a bar code, etc., and/or an electronic reader for reading gateway tag 45 where gateway tag 45 comprises an electronic tag such as an NFC code or an RFID code.

In a preferred form of the present invention, the user's smartphone, tablet, personal computer, smartwatch, smartglasses, etc. communicates with the machine's closed peer-to-peer networking technology (and/or to the machine) using Hypertext Markup Language (HTML) as the web-based protocol. Using HTML as the web-based protocol for communications between the user's handheld device and the machine is preferred, since then the web browser of the handheld device can be used as the communication portal for accessing the machine's internal control dashboard 60.

Once the user's handheld device (e.g., smartphone, tablet, personal computer, smartwatch, smartglasses, etc.) is linked to the machine's internal motherboard web generator 55 (contained within motherboards 57 on gas pump 10, vending machine 15 or car 20) by radio wave (via antennas 50) or light modulation (via “pulsation by light” communication ring system 35), the machine will display its internal control dashboard 60 for gas pump 10, vending machine 15 or car 20, and/or electronic payment methods (if needed), directly onto the web browser 30 of the user's smartphone, tablet, personal computer, smartwatch, smartglasses, etc. (displayed on display screen 27 of handheld device 5). In other words, motherboard 57 provides a peer-to-peer proximity wireless communication facility (either using an RF-based technology such as WiFi, Bluetooth, ZigBee, etc.) via antennas 50, or optically using LiFi via “pulsation by light” communication ring system 35 and the camera of the handheld device (and, to provide bidirectional communication, via the built-in flash/flashlight of the handheld device, and a light sensor, not shown, located on the machine) etc., and internal motherboard web generator 55 provides a web-based communication facility (e.g., a Hypertext Markup Language (HTML)-based communication facility). Since connections are only performed via the machine's closed peer-to-peer proximity wireless communication array (via antennas 50), or closed peer-to-peer LiFi wireless optical networking technology (via “pulsation by light” communication ring system 35), this offers the advantage of interfacing in a simple manner with any machine (e.g., gas pump 10, vending machine 15 or car 20) in environments where cellular telephone (e.g., GSM) and wireless internet connections may not always be available or desirable.

Furthermore, if a user has not been able to download the universal gateway app 25 (shown on display screen 27 of handheld device 5) before wanting to use a particular machine (gas pump 10, vending machine 15 or car 20), and no cellular telephone (e.g., GSM) or wireless internet connections are available for downloading the universal gateway app 25 (shown on display screens 27 of handheld device 5), the machine will also have written under its optical code tag 45 (or at another location on the machine) a set of access instructions 65 on gas pump 10, vending machine 15 or car 20 for the user to follow in order to manually connect their smartphone, tablet, personal computer, smartwatch, smartglasses, etc. with the machine, i.e., the written instructions will preferably contain the following information:

a. the name of the specific proximity peer-to-peer machine network ID; and

b. the machine-specific IP address so that the user may manually connect the web browser 30 of their smartphone, tablet, personal computer, smartwatch, smartglasses, etc. to the machine's internal control dashboard 60 via the web-based peer-to-peer proximity wireless communication system of the present invention.

It should be appreciated that the machine may be wired directly to the Internet, or may be equipped with satellite means for connecting to the Internet, but this is intended to be solely for the purpose of machine maintenance or internal motherboard web generator firmware updates designed to improve the machine-to-smartphone, tablet, personal computer, smartwatch, smartglasses, etc. user interface experience. This connection to the Internet is intended to be solely dedicated to the machine and is not designed to deliver Internet access to the public. However, in case there are no Internet connections available, the machine can still be maintained, or have its firmware updated, by direct machine-to-personal computer or tablet maintenance units via the peer-to-peer proximity wireless communication array (accessed via antennas 50) or via the peer-to-peer LiFi optical communication array (accessed via “pulsation by light” communication ring system 35) provided on the machine.

Once the personal handheld device has been connected to the machine's web-based control system, an option to download the universal gateway app 25 from the machine can be offered in case a user did not have time to previously download the universal gateway app 25 and if the user is unable to connect to a GSM or WiFi network. To this end, a copy of the universal gateway app 25 is stored in memory on each machine so that it can be accessed and downloaded to a handheld device which has been manually connected to that machine. Therefore, no Internet access is necessary for the user to download the universal gateway app 25 to the handheld device 5.

2. Other Applications

The gas station application discussed above is intended to be merely exemplary of one particular application of the present invention. The present invention may be used in many other applications as well.

By way of example but not limitation, this invention is particularly useful in a laboratory environment (FIG. 2) where numerous analytical instrumentations are commonly installed—see ductless (filtration) fumehood 70, air filtration ceiling unit 75, under bench chemical storage cabinet 80, ducted fumehood 85 and analytical instruments 90 (e.g., precision scales, chromatographs, shakers, chillers, etc.), all needing to be used with a high degree of flexibility via a common control technology designed to provide safety through simplicity.

This invention is also compatible with a wide array of other machines or equipment currently in use, e.g., automatic teller machines (ATMs), copy machines, washing machines, televisions, etc. It also offers the advantage of enabling machines that are cheaper to produce and maintain, while also being harder to damage, since the machines do not need keyboards, coin-operating functions or expensive touchscreen displays which can be vandalized.

3. A Step-by-Step Example Using a Ductless (Filtration) FumeHood Incorporating the Invention (FIG. 2, “the Laboratory”)

Step 1:

A lab technician is in a laboratory (FIG. 2) and needs to use a ductless (filtration) fumehood 70. The ductless (filtration) fumehood can be quickly and easily identified from afar as it is equipped with a white color ring or bar (lit or unlit) located at the front (or another portion) of the fumehood (i.e., “pulsation by light” communication ring system 35) so that even colorblind people can see the fumehood. Furthermore, the ductless (filtration) fumehood 70 will also have a gateway tag 45 (an optical QR code, an optical bar code, an electronic NFC tag, an electronic RFID tag, etc.) located at the front (or another portion) of the fumehood.

Step 2:

Once in front of the ductless (filtration) fumehood 70, the lab technician will have to determine the status of the fumehood.

If the white ring or bar of the “pulsation by light” communication ring system 35 (located at the front of the fumehood) is unlit, this means that the fumehood is turned off and/or is unplugged.

If the white ring or bar of the “pulsation by light” communication ring system 35 is lit and steady (i.e., non-flashing light rings), this means that the ductless (filtration) fumehood has been plugged in and turned on, and that it is ready for use and working according to safety parameters.

If the white ring or bar of the “pulsation by light” communication ring system 35 of the ductless (filtration) fumehood is lit and flashing, it means that the fumehood is reporting a problem linked to a safety parameter requiring immediate attention. Since the ductless (filtration) fumehood is not equipped with a screen or keyboard to immediately communicate with the user, an audible “Morse code-type” alarm will be generated along with the Morse code-type flashing of the ring or bar of the “pulsation by light” communication ring system 35, i.e., in the form of a specific number of sound and/or light pulsations, with the number of sound pulses and/or light pulses corresponding to a specific type of alert so that even sound-impaired personnel can be alerted. In order for the user to understand the alert type represented by the audible “Morse code-type” alarm and/or the “Morse-code type” light pulsations, a set of machine status symbols 40 is printed on the front (or another portion) of the ductless (filtration) fumehood 70 in order to inform the user as to the alarm type he/she is facing without having to revert to any specific written language. For example, machine status symbols 40 may be configured to indicate that one sound and/or light pulsation (“pulse”) means that a routine filter maintenance check must be performed; two sound and/or light pulsations (“pulses”) means that there is a containment problem due to a low front face air velocity speed; three sound and/or light pulsations (“pulses”) means there is a problem due to a saturation of the fumehood's main molecular filter; and four sound and/or light pulsations (“pulses”) means there is a problem with the fumehood fan.

(i) Note Re the Light and Sound Pulsations

It should be appreciated that this simple system of alert communication, by a pulsing ring or bar of white light and pulsing sound, with the “Morse code-type” pulses providing alert information to the user, brings many benefits associated with safety, since it can be seen from afar, even from behind a window or a glass door. This simple alert communication system can also be heard with its distinctive sound pulsation (which is synchronized with the pulsation of the ring or bar of white light) without reverting to any specific written language, since these sound and light pulsations correspond to machine status symbols 40 on the front (or another portion) of each machine which explain, in a non-verbal written language, what is going on with the machine. An additional benefit is that this simple light and sound communication system is so incorporated into the product design that it also becomes a distinctive signature that everyone will instantly recognize and therefore understand as a common way of identifying and interfacing with any machine incorporating this feature of the present invention, e.g., the pulsating light rings and pulsating sound on ductless (filtration) fumehoods 70, air filtration ceiling units 75, under bench chemical storage cabinets 80, ducted fumehoods 85 and analytical instruments 90). It is to be noted that other combinations of sound and/or light pulsations can be associated with other alarm types adapted to other laboratory equipment or to any other type of equipment not associated with the laboratory world. It should also be noted that the rings or bars of light of the “pulsation by light” communications ring system 35 may be of any color, e.g., white, blue, red, etc.

Step 3:

As seen in Steps 1 and 2 above, and as a part of the invention, the ductless (filtration) fumehood 70 is using a primary level of communication based on a combination of (i) light (e.g., light rings on the ductless (filtration) fumehood), (ii) sound, and (iii) symbols (e.g., machine status symbols 40 on the ductless (filtration) fumehood 70), all designed to increase the safety of use through the simplicity of the alert. However, if a lab technician needs to go into further detail regarding the nature of the alert, he/she can access an information-rich environment beyond the primary level described above.

As described in Step 1, once the machine has been identified, the person will notice on the front (or another portion) of the machine the gateway tag 45 (e.g., an optical QR tag, an optical bar code tag, an electronic NFC tag, an electronic RFID tag, etc.) which will act as a gateway into the wireless web-based control system of the machine. In order to achieve this connection, the lab technician will use a smartphone, tablet, personal computer, smartwatch, smartglasses, etc. (e.g., handheld device 5), equipped with optical and/or electronic tag reading capability and wireless communication capability, and choose one of two methods to connect the smartphone, tablet, personal computer, smartwatch, smartglasses, etc. directly to the ductless (filtration) fumehood's embedded wireless local area network (e.g., via wireless antenna 50 or via the “pulsation by light” communication ring system 35 which provide optical networking access to the machine).

(i) First Method to Connect

The first method to connect is to download from the Internet a very simple app (i.e., the universal gateway app 25 shown running on display screen 27 of handheld device 5) for their smartphone, tablet, personal computer, smartwatch, smartglasses, etc. This universal gateway app 25 is designed to read and decode the gateway tag 45 (e.g., the optical QR tag, the optical bar code tag, the electronic NFC tag, the electronic RFID tag, etc.) located on the front (or another portion) of the ductless (filtration) fumehood after the gateway tag has been scanned by the camera of handheld device 5 (e.g., the smartphone, tablet, personal computer, smartwatch, smartglasses, etc.) or read by the NFC or RFID readers of the handheld device 5. Once the gateway tag 45 has been scanned and decoded by the universal gateway app 25 (shown running on display screen 27 of handheld device 5), the universal gateway app 25 will cause, through its programming, the handheld device 5 to automatically wirelessly connect onto the machine's peer-to-peer embedded network via antenna 50 (or through “pulsation by light” communication ring system 35) and access, via the web browser 30 of the smartphone, tablet, personal computer, smartwatch, smartglasses, etc., the ductless (filtration) fumehood's internal control dashboard 60 generated by the internal motherboard web generator 55.

In essence, the universal gateway app 25 acquires from gateway tag 45 all of the information needed to connect handheld device 5 to the control system of the machine via the machine's peer-to-peer embedded network, and then automatically effects that connection so as to display the internal control dashboard 60 for the machine using the web browser 30 of the handheld device 5 via a web-based protocol (e.g., via a Hypertext Markup Language (HTML)-based protocol or via another web-based networking protocol that will be apparent to one skilled in the art in view of the present disclosure).

(ii) Second Method to Connect

The second method of connecting handheld device 5 to the ductless (filtration) fumehood 70 is to perform a manual device-to-machine link-up (i.e., to perform a manual link-up of the user's smartphone, tablet, personal computer, smartwatch, smartglasses, etc. to the ductless (filtration) fumehood). More particularly, if the universal gateway app 25 has not previously been downloaded to the user's handheld device 5, and if no cellular telephone (e.g., GSM) or wireless Internet (e.g., WiFi) connections are available for downloading the universal gateway app 25 to the user's smartphone, tablet, personal computer, smartwatch, smartglasses, etc., the filtration fumehood will also have printed, on the front (or another portion) of the machine, under its gateway tag 45 (e.g., an optical QR code, an optical bar code, an electronic NFC code, an electronic RFID code, etc.), the manual access instructions 65 needed to enable the user to perform a manual device-to-machine link-up. These access instructions 65 preferably include:

a. the peer-to-peer wireless technology type (WiFi, NFC, Bluetooth, ZigBee, LiFi, etc.) embedded into the machine;

b. the name of the specific proximity peer-to-peer machine network ID; and

c. the machine-specific IP address,

so that the user may manually connect the web browser 30 of their smartphone, tablet, personal computer, smartwatch, smartglasses, etc. to the filtration fumehood's internal control dashboard 60 using the peer-to-peer machine network and a web-based communication protocol.

(iii) Note Re the Universal Gateway App

It should be appreciated that this universal gateway app 25 is not a “controlling” app of the sort which is typically bundled with a “connected object” or a “connected machine”, where the “controlling” app is specifically tailored to the “connected object” or the “connected machine” with which it is paired. Rather, the universal gateway app 25 of the present invention is designed to be universal and not linked to a particular product, or even to a particular brand of products. The universal gateway app 25 is, essentially, a protocol that is designed to quickly and easily connect, wirelessly, to any machine after the app has decoded a gateway tag 45, using handheld device 5, where gateway tag 45 incorporates the information required to enable automatic device-to-machine link-up. This information preferably includes:

a. the nature of the peer-to-peer wireless technology (WiFi, NFC, Bluetooth, ZigBee, LiFi, etc.) embedded into the machine;

b. the identification of the machine's specific network ID name; and

c. the identification of the machine's specific IP address.

After the gateway tag 45 (i.e., the “optical code tag”) located on the front (or another portion) of the machine has been decoded by the universal gateway app 25 running on the user's smartphone, tablet, personal computer, smartwatch, smartglasses, etc., the universal gateway app 25 will automatically trigger the web browser 30 of the smartphone, tablet, personal computer, smartwatch, smartglasses, etc. so that the machine which is to be controlled can push its internal control dashboard 60, with the help of its embedded web generator 55, via its peer-to-peer wireless link (e.g., wireless antenna 50 or “pulsation by light” communication ring system 35), directly onto the display screen 27 of the smartphone, tablet, personal computer, smartwatch, smartglasses, etc. which is running the web browser 30. This simple universal gateway app 25 can therefore replace thousands of conventional proprietary desktop-hungry and memory-hungry “controlling” apps which otherwise could very quickly overload the desktop and memory space of the user's smartphone, tablet, personal computer, smartwatch, smartglasses, etc. each time a user needs to connect to a new machine.

It should also be appreciated that with the present invention, the internal control dashboard 60 displayed on display screen 27 of handheld device 5 enables full, bi-directional operation of the machine, i.e., so that the machine can use the display screen of handheld device 5 for all user input/output and no longer needs an on-board display screen to control operation of the machine.

In addition to the foregoing, in one preferred form of the invention, universal gateway app 25 is configured to (i) download to handheld device 5 the “operational logs” of a machine when handheld device 5 is connected to the machine, and (ii) thereafter upload from handheld device 5 the “operational logs” of that machine to a remote site (e.g., a manufacturer's database) when the handheld device has connectivity to the internet or a cellular network. In this way, the “operational logs” of the machine can be collected from the machine and provided to a remote site using the universal gateway app 25 and the handheld device.

Step 4:

Once a network connection has been established between the peer-to-peer wireless network of the ductless (filtration) fumehood 70 (generated by internal motherboard web generator 55) and the user's smartphone, tablet, personal computer, smartwatch, smartglasses, etc. via the universal gateway app 25, the internal web service generator (i.e., internal motherboard web generator 55) of the ductless (filtration) fumehood will automatically display its internal control dashboard 60 onto the web browser 30 of the user's smartphone, tablet, personal computer, smartwatch, smartglasses, etc. in the natural language already associated with their smartphone, tablet, personal computer, smartwatch, smartglasses, etc. (e.g., English, French, German, etc.). In doing so, a user will be able to access information about ductless (filtration) fumehood performance, usage statistics, parameters, history logs, etc.

Step 5:

If a user needs to use another ductless (filtration) fumehood 70, or an air filtration ceiling unit 75, or an “under bench” chemical storage cabinet 80, or a ducted fumehood 85, or a series of analytical instruments 90 (e.g., precision scales, chromatographs, shakers, chillers, etc.), the user will be able to do so by simply scanning the gateway tag 45 (e.g., the optical QR code, optical bar code, the electronic NFC code, the electronic RFID code, etc.) located on the front (or another portion) of each new machine to be used (i.e., using Step 3, first method of connection, above). Once again, if the universal gateway app 25 is not already on the user's handheld device 5, and if no Internet services or cellular networks are available to download universal gateway app 25 to their handheld device 5, the user can manually connect (using Step 3, second method of connection, above) their smartphone, tablet, personal computer, smartwatch, smartglasses, etc. to any machine equipped with the above-mentioned technological features since it is the machine itself which houses the hardware and software needed to connect with the web browser carried by the user's smartphone, tablet, personal computer, smartwatch, smartglasses, etc. Significantly, the user can then download the universal gateway app 25 to their handheld device 5 from the machine which their handheld device 5 is connected to, whereupon the user can thereafter automatically connect to another machine using the downloaded universal gateway app 25 and the gateway tag 45 located on the machine which they wish to access.

4. Summary of the Components of the Present Invention (FIG. 3, “the Components”) and their Operation

A ring or bar of white (or other color) light (e.g., “pulsation by light” communication ring system 35), encircling or in front of the machine, offering two functions:
a. a simple man-machine interface by light and sound pulsation codes that does not necessitate the use of a traditional display screen; and
b. a simple identification marker that can be seen from afar that tells a user that he/she can use this machine with his/her smartphone, tablet, personal computer, smartwatch, smartglasses, etc.

A gateway tag 45, e.g., an optical QR code, an optical bar code, an electronic RFID code, an electronic NFC code, etc., affixed on the front (or another portion) of each machine, acting as a direct connection gateway into the machine's web dashboard generator for use with a smartphone, tablet, personal computer, smartwatch, smartglasses, etc. equipped with a web browser.

A set of machine status symbols 40 printed on the front (or another portion) of the machine (e.g., a ductless (filtration) fumehood 70) informing the user as to the meaning of the alarm type he/she is receiving without having to revert to any specific written language.

A manual link-up notification sticker (access instructions 65) for manually linking up a smartphone, tablet, personal computer, smartwatch, smartglasses, etc. to the machine: if no cellular telephone (e.g., GSM) or wireless internet connections are available for downloading the universal gateway app 25, the machine (e.g., the ductless (filtration) fumehood) will also have written, under its gateway tag 45 (i.e., the QR code, bar code, NFC code, RFID code, etc.) at the front (or another portion) of the machine, the information needed to effect a manual link-up between the machine and the handheld device, which preferably includes the following information:

a. the peer-to-peer wireless technology type (WiFi, NFC, Bluetooth, ZigBee, LiFi, etc.) embedded into the machine;

b. the name of the specific proximity peer-to-peer machine network ID; and

c. the machine-specific IP address so that the user may manually connect the web browser of their smartphone, tablet, personal computer, smartwatch, smartglasses, etc. to the machine's internal control dashboard 60.

A universal gateway app 25 acting as an optical or wireless linking key for the user's smartphone, tablet, personal computer, smartwatch, smartglasses, etc., designed to read and decode the gateway tag 45 (i.e., the optical QR, the optical bar code, the electronic NFC code, the electronic RFID code, etc.) located at the front (or another portion) of the machine so that the smartphone, tablet, personal computer, smartwatch, smartglasses, etc. will automatically wirelessly connect onto the machine's peer-to-peer embedded network.

A machine self-generated embedded peer-to-peer wireless local area network 95 for connecting directly with any smartphone, tablet, personal computer, smartwatch, smartglasses, etc. without the need of an Internet or cellular connection.

An embedded web service virtual dashboard (i.e., internal control dashboard 60), preferably directly integrated into the machine's motherboard 57, which allows a user, through the web browser 30 of his/her smartphone, tablet, personal computer, smartwatch, smartglasses, etc., to bi-directionally take control of a machine while not having to download any specific memory-intensive app for each different machine which can overload the dashboard and memory space of a handheld device.

A portable device (e.g., handheld device 5 such as a smartphone, tablet, personal computer, smartwatch, smartglasses, etc.) equipped with an optical recognition apparatus 100 (e.g., a camera with optical recognition software) and/or RFID tag reader 105, and/or LiFi reader 110 (e.g., a light sensor) and/or NFC reader 115, and a web browser 30 which, once linked to the machine's embedded web service control dashboard 60, can bi-directionally take full control, by wireless means 60, of any machine equipped with this set of technologies.

5. Generic System Schematic (FIG. 4)

Thus it will be seen that, with the preferred form of the invention, and looking now at FIG. 4, each machine comprises:

(i) a light ring or bar for “announcing” the machine's presence to a user, and for providing “Morse code-type” alerts to a user, and for providing light communication with a user's smartphone, tablet, personal computer, smartwatch, smartglasses, etc.;

(ii) a loudspeaker for providing “Morse code-type” alerts to a user;

(iii) a peer-to-peer wireless local area network equipped with a web-based protocol interface for connecting directly with the web browser of the user's smartphone, tablet, personal computer, smartwatch, smartglasses, etc.;

(iv) an embedded web service virtual dashboard directly integrated into the machine's motherboard for enabling a user to take control of the machine's operation using a web browser on the user's smartphone, tablet, personal computer, smartwatch, smartglasses, etc.;

(v) a gateway tag affixed to the front (or another portion) of the machine for reading by a universal gateway app running on the user's smartphone, tablet, personal computer, smartwatch, smartglasses, etc.; and

(vi) manual instructions printed on the front (or another portion) of the machine for enabling a user to manually connect the web browser of their smartphone, tablet, personal computer, smartwatch, smartglasses, etc. to the machine.

And it will be seen that with the preferred form of the invention, the user's portable device (smartphone, tablet, personal computer, smartwatch, smartglasses, etc.) comprises:

(vii) an optical reader (or electronic reader) capable of reading the gateway tag affixed to the front (or another portion) of the machine;

(viii) a web browser; and

(ix) a universal gateway app for using the image/data obtained by the optical (or electronic) reader to connect the web browser of the portable device to the peer-to-peer wireless local area network of the machine and link the web browser to the embedded web services virtual dashboard of the machine.

It will also be seen that, in one preferred manner of use, the user approaches the machine, having noticed the ring or bar of light incorporated into the machine, and is immediately advised of the status of the machine by the ring or bar of light, as well as being advised of any alerts associated with the machine by the “Morse code-type” light pulsations of the ring or bar of light and the “Morse-code type” audio pulsations provided by the loudspeaker.

Next, the user uses the Internet to download the universal gateway app onto their smartphone, tablet, personal computer, smartwatch, smartglasses, etc., if the universal gateway app is not already loaded onto their smartphone, tablet, personal computer, smartwatch, smartglasses, etc.

Then the user scans (optically or electronically) the gateway tag on the front (or another portion) of the machine, and the universal gateway app uses the information embedded into the gateway tag to automatically connect the web browser on the user's smartphone, tablet, personal computer, smartwatch, smartglasses, etc. to the embedded web service virtual dashboard of the machine, so that the user can use their web browser to bi-directionally control operation of the machine.

Note that if the machine is located in a place where there is no Internet or cellular telephone connection, the user can use the manual access instructions provided on the front (or another portion) of the machine to manually connect the web browser of their smartphone, tablet, personal computer, smartwatch, smartglasses, etc. to the embedded web service virtual dashboard of the machine.

6. Collections of Machines

Although the present invention has been discussed in the context of a system enabling control of a single machine, it should be appreciated that the system of the present invention may also be used to control a collection of machines, rather than a single machine, with each machine providing the user with a machine-specific dashboard, or with each machine interfacing with a common dashboard.

By way of example but not limitation, the system of the present invention may be used to control all of the electronic devices/machines present in a single room (e.g., a hotel room). In such a control scheme, each electronic device/machine would be configured to connect to a network (e.g., a wireless network) and configured for operational control via that network. A “constellation” of such electronic devices/machines would be configured to generate a localized peer-to-peer network, such that each machine was linked together through the network. A personal handheld device (e.g., a smartphone) having an appropriate universal gateway app could be used to scan a gateway tag located in the room (e.g., on a wall of the room), whereby to obtain the identity of the localized peer-to-peer network and connect thereto (e.g., via a web browser). A user could then use the personal handheld device (e.g., a smartphone) to control each of the electronic devices/machines present in the single room, either through a single dashboard or through a constellation of dashboards.

7. Retrofit of Machines

In still another form of the present invention, existing machines could be retrofitted so as to enable self-generation of a localized peer-to-peer network with a web-based protocol interface and to facilitate control of that machine via a dashboard presented to a portable electronic device connected to that localized peer-to-peer network.

By way of example but not limitation, if desired, the system of the present invention may be facilitated by a device configured to integrate with (or electronically communicate with) existing machines via a hard link (e.g., a USB connection). Such a USB device would comprise (1) a network-generating means for generating a localized peer-to-peer network (or for joining an existing localized peer-to-peer network), and (2) an interface for interfacing with the existing machine (e.g., a television set) so as to enable control of the functions of the existing machine (e.g., the television set) via a web-based dashboard presented on the localized peer-to-peer network (and hence, to allow the control of the functions of the existing machine via the web browser of a handheld device communicating with the localized peer-to-peer network). By way of further example but not limitation, a conventional fumehood having a USB port could be controlled using the present invention by (1) plugging the aforementioned USB device into the USB port of the conventional fumehood, and (2) placing a gateway tag on the front (or another portion) of the machine. The enhanced fumehood could then be controlled by a hand-held device, e.g., one equipped with the universal gateway app, a gateway tag reader, and a web browser.

8. Conclusion

When combined, these technologies will act as a package designed to provide a universal means to easily interface with, and take full control of, any standalone machine, using a compact and universal app (i.e., the universal gateway app) which will act as an automated gateway key into a variety of machines without having to use built-in screens, touchscreens or keyboards for each machine used, and without having the need to be connected to the Internet to download a manufacturer's specific “controlling” app or central data-gathering server, since each machine will generate its own local area network, data-gathering database and bi-directional dashboard web generator for use with any portable devices (smartphone, tablet, personal computer, smartwatch, smartglasses, etc.) already loaded with web browsing functions.

Using this invention can have the positive effect of lowering costs, simplifying the design and environmental footprint associated with machine development and production, as well as lowering the costs associated with complex app development for each machine, often associated with large internet or network infrastructures, while offering users a global, simple and universal means of interfacing with a plurality of machines without having to saturate the desktop space or memory space of their smartphone, tablet, personal computer, smartwatch, smartglasses, etc.

### MODIFICATIONS OF THE PREFERRED EMBODIMENTS

It should be understood that many additional changes in the details, materials, steps and arrangements of parts, which have been herein described and illustrated in order to explain the nature of the present invention, may be made by those skilled in the art while still remaining within the principles and scope of the invention.

What is claimed is:

1. A system comprising:
a machine comprising:
a local, wireless, peer-to-peer network with a unique network identifier and a unique machine identifier;
an interface for enabling web browser-based communications over the network;
a dashboard generator for providing a machine control dashboard for controlling operation of the machine over the network; and
a gateway tag associated with the machine for wirelessly providing all of the information required to access the network and the machine control dashboard for the machine; and
a portable device enabled for web browser-based communications over the network and configured to acquire the gateway tag and to use the information from the gateway tag to automatically connect to the network and the machine so that the machine control dashboard is displayed on the portable device, whereby to enable the machine to be controlled by the machine control dashboard displayed on the portable device.

2. A system according to claim 1 wherein the portable device comprises a universal gateway app configured to acquire the gateway tag from the machine and use the information from the gateway tag to automatically connect to the network and the machine so that the machine control dashboard is displayed on the portable device, whereby to allow the machine to be controlled by the machine control dashboard displayed on the portable device.

3. A system according to claim 2 wherein the portable device comprises a web browser, and further wherein the universal gateway app causes the machine control dashboard to be displayed via the web browser of the portable device.

4. A system according to claim 2 wherein the universal gateway app is downloadable to the portable device using an Internet or cellular telephone connection.

5. A system according to claim 2 wherein the universal gateway app is downloadable to the portable device from the machine.

6. A system according to claim 5 wherein a copy of the universal gateway app is stored in memory on the machine.

7. A system according to claim 1 wherein the network utilizes RF-based technology.

8. A system according to claim 7 wherein the network utilizes one from the group consisting of WiFi, Bluetooth and ZigBee technology.

9. A system according to claim 7 wherein the network utilizes LiFi technology.

10. A system according to claim 1 wherein the gateway tag comprises an optical tag.

11. A system according to claim 10 wherein the optical tag comprises at least one from the group consisting of a QR code and a bar code.

12. A system according to claim 10 wherein the handheld device uses a camera to read the optical tag.

13. A system according to claim 1 wherein the gateway tag comprises an electrical tag.

14. A system according to claim 13 wherein the electrical tag comprises at least one from the group consisting of an NFC electrical code and an RFID electrical code.

15. A system according to claim 13 wherein the handheld device uses at least one from the group consisting of an NFC reader and an RFID reader.

16. A system according to claim 1 wherein the interface for enabling web browser-based communications over the network supports the HyperText Markup Language (HTML) protocol.

17. A system according to claim 1 wherein the machine comprises a laboratory machine selected from the group consisting of ductless (filtration) fumehoods, air filtration ceiling units, under bench chemical storage cabinets, ducted fumehoods and analytical instruments.

18. A system according to claim 2 wherein the universal gateway app is configured to (i) download to the portable device the operational logs of the machine when the portable device is connected to the machine, and (ii) thereafter upload from the portable device the operational logs of the machine to a remote site when the portable device has connectivity to the Internet or a cellular network.

19. A system according to claim 1 wherein the portable device comprises one from the group consisting of a smartphone, a tablet, a personal computer, a smartwatch, and smartglasses.

20. A system according to claim 1 wherein the network, the interface and the dashboard generator are all integrated with the machine at the time of machine manufacture.

21. A system according to claim 1 wherein the network, the interface and the dashboard generator are added to the machine after the time of machine manufacture.

22. A system according to claim 21 wherein the network, the interface and the dashboard generator are added to the machine after the time of machine manufacture using a USB connection.

23. A system according to claim 1 wherein the machine further comprises a light and a loudspeaker, and further wherein the machine is configured to provide alerts by generating patterns of light pulses using the light and patterns of noise pulses using the loudspeaker, wherein the patterns of light pulses and noise pulses are synchronized with one another, and further wherein each pattern represents a different type of alert.

24. A method comprising:
providing a system comprising:
a machine comprising:
a local, wireless, peer-to-peer network with a unique network identifier and a unique machine identifier;
an interface for enabling web browser-based communications over the network;
a dashboard generator for providing a machine control dashboard for controlling operation of the machine over the network; and
a gateway tag associated with the machine for wirelessly providing all of the information required to access the network and the machine control dashboard for the machine; and
a portable device enabled for web browser-based communications over the network and configured to acquire the gateway tag and to use the information from the gateway tag to automatically connect to the network and the machine so that the machine control dashboard is displayed on the portable device, whereby to enable the machine to be controlled by the machine control dashboard displayed on the portable device;
using the portable device to acquire the gateway tag and automatically connect to the network and the machine so that the machine control dashboard is displayed on the portable device; and
controlling operation of the machine over the network using the machine control dashboard on the portable device.

25. A machine comprising:
a local, wireless, peer-to-peer network with a unique network identifier and a unique machine identifier;
an interface for enabling web browser-based communications over the network;
a dashboard generator for providing a machine control dashboard for controlling operation of the machine over the network; and
a gateway tag associated with the machine for wirelessly providing all of the information required to access the network and the machine control dashboard for the machine.

26. A machine according to claim 25 wherein the machine comprises memory, and further wherein a universal gateway app is stored in the memory of the machine, wherein the universal gateway app is downloadable from the machine to a portable device, and further wherein the universal gateway app is configured to enable the portable device to acquire the gateway tag from the machine and use the information from the gateway tag to automatically connect to the network and the machine so that the machine control dashboard is displayed on the portable device, whereby to allow the machine to be controlled by the machine control dashboard displayed on the portable device.

27. A software app for a portable device, wherein the portable device is enabled for web browser-based communications over a network and configured to acquire a gateway tag, the software app being configured to use the information from the gateway tag to automatically connect to the network, and to a machine also connected to the network, so that a machine control dashboard provided to the network is displayed on the portable device.
